(19) United States
(12) Patent Application Publication
(10) Pub. No.: US 2005/0107079 A1
(43) Pub. Date: May 19, 2005

(54) Wireless telemetry systems and methods for real time transmission of electromagnetic signals through a lossy environment

(76) Inventors: Roger L. Schultz, Aubrey, TX (US); Craig L. Zitterich, Corinth, TX (US); James E. Masino, Houston, TX (US)

Correspondence Address: JOHN W. WUSTENBERG, P.O. BOX 1431, DUNCAN, OK, 73536, US

(21) Appl. No.: 10/714,332

(22) Filed: Nov. 14, 2003

(51) Int. Cl. H04Q 7/20

(52) U.S. Cl. 455/422.1

(57) ABSTRACT

The current invention relates to novel systems and methods for communicating with equipment and sensors located within a lossy environment. In particular, the current invention provides a wireless telemetry system suitable for use in a lossy environment. The wireless telemetry system provides essentially “real-time” communication between subsurface devices and the surface. Additionally, the current invention provides a method for positioning wireless transceivers used in the telemetry systems of the current invention.

### BACKGROUND

The need to transmit electromagnetic signals through a lossy environment is commonly encountered in the hydrocarbon production industry. In order to enhance the efficiency and life of a petroleum production well, sensors capable of monitoring the physical and chemical conditions within a borehole are commonly placed within the borehole. As downhole conditions change over the life of the well, the operator has the option of performing various borehole treatments designed to prolong the life of the well. Currently available sensors are capable of monitoring parameters such as, but not limited to, downhole radiation, fluid composition, pressure, temperature, pH, water hardness and changes in the flow rates of hydrocarbons and water.

One common area of concern in hydrocarbon producing wells is the generation of scale on the production tubular. In most instances the operator would prefer to preclude the formation of scale as opposed to removing the scale buildup. Scale prevention typically involves monitoring of the downhole environment by means of downhole sensors for the development of conditions suitable for the formation of scale. When such conditions are detected the operator can react with the appropriate well treatment. Water production in hydrocarbon producing wells is another common problem. To preclude the production of water, the operator attempts to isolate the water producing area by means of packers and other isolating tools. Downhole sensors and use of a remotely operated packer permits the early detection and isolation of water in the borehole thereby enhancing well operations.

In addition to downhole sensors, a variety of downhole tools have been developed for placement in the hole as part of the production pipe string. These tools include submersible pumps, valves, packers, side pocket mandrels and other equipment designed for particular purposes. Typically, these tools are activated remotely from the surface by means of a signal transmitted over a wire, the pipe string or as a change in pressure within the fluid located within the borehole.

Communication with the various tools and sensors located several thousand feet beneath the service by wire is prone to failure due to the extreme conditions encountered downhole. Accordingly, various attempts have been made to develop a satisfactory wireless communication system. Unfortunately, currently available wireless systems are limited by attenuation of the wireless signal by the lossy media commonly found in downhole formations. Depending on formation characteristics, i.e. the conductivity of the earth, significant attenuation of the transmitted signal will occur en route from the transmitter to the receiver. In order to minimize signal attenuation, current wireless systems typically utilize transmission frequencies of 10 Hz or less. Unfortunately, the ability of an electromagnetic signal to carry data (bits) is directly proportional to the frequency of the signal. Thus, a reduction in frequency also reduces the amount of data carried by the signal.

To overcome this problem, the industry currently uses data buffering repeaters within the borehole. In these systems a data-buffering repeater receives and stores the entire data stream prior to transmitting the data to the next repeater in the system. Thus, every data buffering repeater increases transmission time by 100%. Clearly, currently available systems do not permit “real time” communication through a lossy environment.

Accordingly it would be beneficial to provide a wireless telemetry system capable of transmitting electromagnetic signals through a lossy environment at high frequencies without loss of reception due to attenuation. As used herein, an electromagnetic signal is a data carrying signal. Further, the wireless telemetry system should provide real time or nearly real time communication through the lossy environment. Additionally, it would be helpful if the wireless telemetry system could accommodate the failure of an individual transceiver without losing contact with the remaining devices within the lossy environment.

### SUMMARY

The current invention provides a method for positioning wireless transceivers in a lossy environment. The method of the current invention comprises the steps of determining the attenuation factor throughout the lossy environment and selecting at least one transmission frequency. The current invention positions the transceivers a distance apart selected to ensure reception of the electromagnetic signal.

In another embodiment the current invention provides a method for positioning electromagnetic transceivers within a borehole. The method of the current invention comprises the steps of determining the resistivity of a given length of borehole and determining the attenuation profile of the given length at a selected frequency. The current invention positions the transceivers a distance apart selected to ensure reception of the electromagnetic signal.

Additionally, the current invention provides a method for transmitting an electromagnetic signal through a subsurface lossy environment. The method of the current invention comprises the steps of determining the attenuation factor for the path of the electromagnetic signal through the lossy environment and selecting at least one transmission frequency. The current invention positions at least one transceiver within the lossy environment and at least one transceiver outside the lossy environment. The distance between the transceivers is selected to ensure reception of an electromagnetic signal. Subsequently, an electromagnetic signal is transmitted from one transceiver to another transceiver through the lossy environment.

In another embodiment the current invention provides a method for transmitting an electromagnetic signal through a lossy environment. This method comprises the steps of determining the attenuation factor throughout the lossy environment and selecting at least one transmission frequency. The method also positions at least two transceivers a distance apart within the lossy environment, the distance between the transceivers being selected to ensure reception of an electromagnetic signal. Subsequently, electromagnetic signals are transmitted from one transceiver to another transceiver through the lossy environment.

Further, the current invention provides a method for the real time transmission of electromagnetic signals to and from the surface through a lossy environment. The method of the current invention comprises the steps of determining the resistivity along the path of the electromagnetic signals through the lossy environment and selecting at least one transmission frequency for the electromagnetic signals. The method also positions at least one transceiver at the surface and positions at least one intermediate transceiver in the lossy environment. Additionally, the method positions at least one target transceiver within the lossy environment. The distance between each transceiver is a distance selected to ensure an attenuation factor at least low enough to permit reception of the transmitted electromagnetic signal. Subsequently the method transmits an electromagnetic signal in real time from the surface transceiver to at least one target transceiver or from at least one target transceiver to the surface transceiver. The electromagnetic signal passes through at least one intermediate transceiver prior to reception.

In another embodiment, the current invention provides a method for the real time transmission of electromagnetic signals from the surface through a lossy environment. The method of the current invention comprises the steps of determining the resistivity along the path of the electromagnetic signals through the lossy environment and selecting at least one transmission frequency for the electromagnetic signals. The method also positions at least one transceiver at the surface and positions at least one intermediate transceiver in the lossy environment. Additionally, the method positions at least one target transceiver within the lossy environment. The distance between each transceiver is a distance selected to ensure an attenuation factor at least low enough to permit reception of the transmitted electromagnetic signal. Subsequently the method transmits an electromagnetic signal in real time from the surface transceiver to the target transceiver. The electromagnetic signal passes through at least one intermediate transceiver prior to reception at the target transceiver.

In yet another embodiment, the current invention provides a method for transmitting data through a subterranean formation using electromagnetic signals comprising the steps of forming at least one passageway through at least part of a subterranean formation. Prior to, during or after formation of the passageway, the current invention determines the resistivity of the subterranean formation along the path of the passageway, selects at least one data transmission frequency and determines the attenuation profile of the subterranean formation along the path of the passageway for the frequencies to be used in the subterranean formation. The current invention then positions transceivers in the passageway such that the amplitude of an electromagnetic signal transmitted between any two transceivers is sufficient to ensure signal reception despite attenuation by the lossy environment. Thereafter, the current invention transmits data through the borehole using electromagnetic signals.

Still further, the current invention provides a method for simultaneously transmitting data upwards and downwards through a borehole using electromagnetic signals comprising the steps of drilling a borehole through at least part of a subterranean formation and determining the resistivity of the subterranean formation along the path of the borehole. Additionally, the method includes selection of at least one frequency for transmitting data and determines the attenuation profile of the subterranean formation along the path of the borehole for the frequencies to be used in the downhole environment. Further, the current invention positions at least two pairs of transceivers in the borehole such that signal attenuation between any two transceivers is substantially identical throughout the borehole. Thereafter, the current invention transmits data upwards and downwards through the borehole using electromagnetic signals. Preferably the electromagnetic signals are transmitted at frequencies of at least about 15 Hz.

In another embodiment, the current invention provides a wireless telemetry system comprising at least two transceivers positioned within a lossy environment capable of sending and receiving electromagnetic signals. The transceivers are positioned a distance sufficiently close to one another such that the amplitude of a transmitted signal is sufficient to ensure signal reception despite signal attenuation by the lossy environment.

Still further, the current invention provides a system capable of wirelessly transmitting data through a lossy environment using electromagnetic signals transmitted at very low to very high electromagnetic frequencies. Preferred frequencies are between about 15 Hz to about 5 kHz. The system of the current invention comprises a transceiver system for transmitting analog or digital data through a lossy environment. The novel system comprises at least two transceivers for transmitting and receiving data. Additionally, the system comprises at least two mixers for combining electromagnetic signals, at least two high pass filters, at least two band pass filters and at least two high-Q band pass filters. The novel system provides the means for transmitting data between sensors or tools located in a lossy environment in substantially real time. As such, the system does not use data buffering repeaters. Therefore, an electromagnetic signal transmitted by this system is received in essentially “real time.”

### BRIEF DESCRIPTION OF THE DRAWINGS

FIG. 1 is a schematic elevation sectioned view of a drill string within a borehole 22 including a wireless telemetry system 10 for communication with downhole tools and sensors.

FIG. 2 is a schematic representation of transceivers 70 as they are utilized in wireless telemetry system 10 of the current invention.

FIG. 3 is a theoretical resistivity well log.

FIG. 4 is a signal attenuation plot calculated using the theoretical resistivity well log.

### DESCRIPTION

I. Wireless Telemetry Systems and Transceivers for Use in Lossy Environments

In one embodiment, the current invention provides a wireless telemetry system capable of real time transmission of data through a lossy environment. As used herein, a lossy environment is a region that attenuates electromagnetic signals. Common lossy environments through which electromagnetic signals are transmitted include regions penetrated by mines, boreholes, caves and caverns. In general, higher frequencies experience a greater degree of attenuation in a lossy environment. As is known to those skilled in the art, downhole formations penetrated by hydrocarbon producing wells are lossy environments.

The wireless telemetry system of the current invention utilizes at least one subsurface transceiver capable of transmitting and receiving an electromagnetic signal. When located within a hydrocarbon producing borehole, the current invention will normally have at least two subsurface transceivers and one surface transceiver. Regardless of the number of transceivers used, the system of the current invention permits transmission of data takes place in “real time.” As used herein, the term “real time” includes the time delay associated with the signal traveling the distance between transceivers and the short period of time associated with relaying the signal through a transceiver. The wireless telemetry system of the current invention does not buffer the transmitted information during the time period from initial transmission to final reception. The ability to avoid buffering of transmitted signals is provided by the ability of the transceivers to receive and demodulate a signal and subsequently modulate a new signal using the demodulated signal. Accordingly, a signal sent from the surface to a downhole tool travels continuously through the wireless telemetry system without intermittent storage. Thus, the current invention avoids the extended delays associated with data buffering repeaters.

While particularly suited for transmission of electromagnetic (EM) signals over long distances through a lossy environment, the high speed, high data capabilities of the current invention will also find application over short lossy environments regions. For example, sampling wells are frequently used to monitor aquifers and to detect trace chemicals. Although signal attenuation may not be a significant problem in the shorter sampling wells, the ability to transmit large quantities of data at high speed will enhance the ability to monitor the subsurface environment.

When transmitting an EM signal over a relatively short distance, the preferred wireless telemetry system will comprise at least one transceiver within the lossy environment and at least one transceiver outside the lossy environment. When transmitting an EM signal over distances greater than about 200 meters, the preferred wireless telemetry system will typically comprise at least two transceivers within the lossy environment and at least one transceiver outside the lossy environment. Regardless of the length of the lossy environment, the transceiver outside the lossy environment normally will be located on the surface of the earth, lake or ocean. Typically, the wireless telemetry system of the current invention transmits and receives data without EM signal loss over these distances at a wide range of frequencies. Preferably, the wireless telemetry system is capable of transmitting EM signals at frequencies of at least 15 Hz with no more than 98% attenuation. Stated in terms of signal amplitude, the amplitude of the received signal is at least 2% of the amplitude of the transmitted signal.

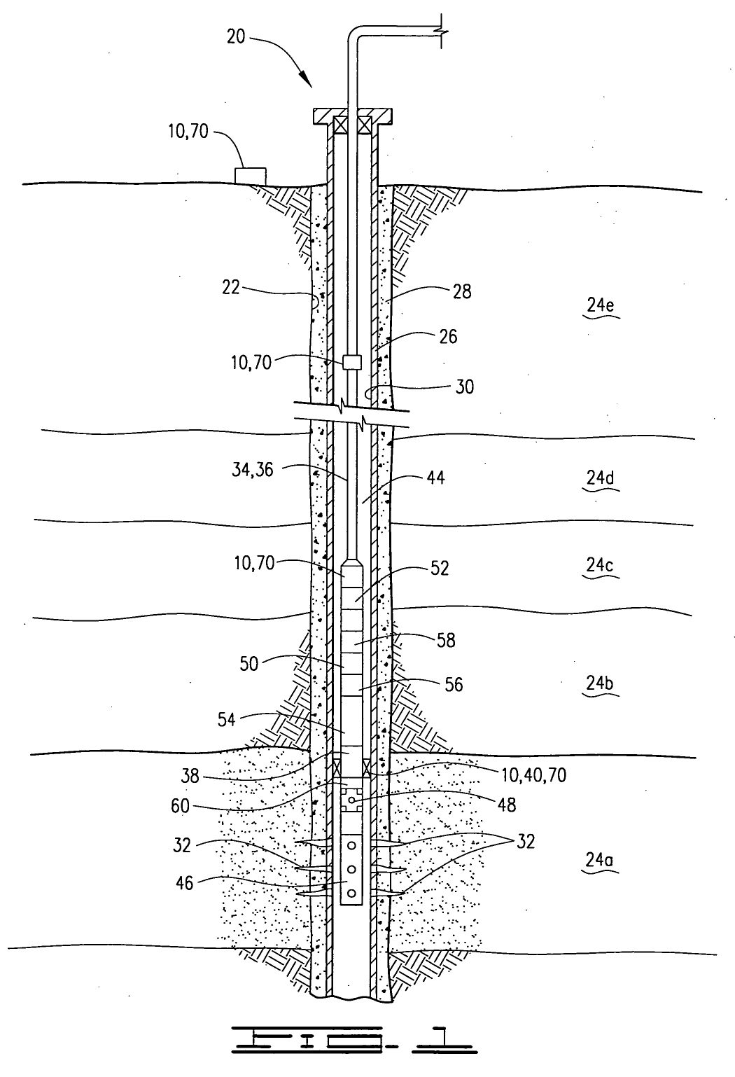

As noted above, the wireless telemetry system 10 of the current invention is suitable for use in a wide range of lossy environments including, but not limited to mines, caves and boreholes. Applications of the current invention in the downhole environment include, but are not limited to drilling, casing and testing operations as well as production operations. As a hypothetical example, wireless telemetry system 10 will be described in a testing environment with reference to FIG. 1. FIG. 1 is a schematic elevational view of a typical oil or gas well 20. The well 20 is formed by a borehole 22 extending down through the earth and intersecting a subterranean formation 24. As known to those skilled in the art, formation 24 typically comprises several differing geological zones. For representation purposes only, FIG. 1 depicts formation 24 as having five zones, 24a-e. A well casing 26 is placed within the borehole 22 and cemented in place therein by cement 28. The casing 26 has a casing bore 30. Multiple perforations 32 extend through the casing 26 and cement 28 to provide communication between the casing bore 30 and the subsurface formation 24.

A drill string or test string generally designated by the numeral 34 is shown in place within well 20. String 34 includes a string of tubing 36 normally comprising a plurality of joints of threaded tubing. String 34 carries a plurality of tools on its lower end. A test packer 38 carries an expandable packing element 40 which seals between the string 34 and the casing bore 30 to define a well annulus 44 therebetween.

The particular string 34 shown in FIG. 1 carries a tubing conveyed perforating gun 46 used to create the perforations 32. A perforated sub 48 located above perforating gun 46 allows formation fluids from the subsurface formation 24 to enter the string 34 and flow upward therethrough under control of a tester valve 50. A reverse circulation valve 52 is typically located above the tester valve 50. An instrumentation package 54 is included to measure, record and transmit various downhole measurements taken by various sensors 60 to the surface. Other tools included in the string 34 may include a sampler 56 and a safety valve 58. Sensors 60 may be installed on the interior and/or exterior of string 34. Sensors 60 appropriate for use in the current invention include any currently known sensors such as, but not limited to, sensors suitable for monitoring downhole radiation, pressure, temperature, pH, water hardness and changes in the flow rates of hydrocarbons and water. Additionally, the current invention is sufficiently adaptable to accommodate new sensors as they are developed by the industry.

Many common downhole tools and sensors are capable of remote operation. Unfortunately, current systems for remotely operating such devices do not permit transmission of large data streams at high transmission rates. Currently available wireless systems operate in the range of 1 Hz to about 10 Hz in order to limit signal attenuation by the lossy environment. Those skilled in the art recognize that electromagnetic signals at such low frequencies carry a very limited quantity of data. Therefore, in order to provide a wireless telemetry system 10 capable of real time transmission of large data streams, the wireless telemetry system 10 of the current invention utilizes transceivers 70 capable of simultaneously receiving and transmitting data over EM frequencies.

As previously indicated, the wireless telemetry system 10 of the current invention is capable of maintaining communication throughout the lossy environment at a signal attenuation of 98% or greater. In general, signal attenuation resulting from the distance between transceivers equal to or less than 98% is preferred, as lower attenuation levels enhance the likelihood of a complete transmission. Thus, less than 90% signal attenuation is preferred over the minimum 98%. Similarly, 80% and 70% attenuation rates are preferred over the 90% attenuation. However, for economic purposes, the preferred wireless telemetry system will be designed to ensure signal attenuation of about 60% or less. Further, the current invention typically provides for substantially identical signal attenuation from one transceiver 70 to the next. In general, lower signal attenuation targets will increase the overall cost of wireless telemetry system 10 as lower signal attenuation will require a greater number of transceivers 70.

In this embodiment, wireless telemetry system 10 will be capable of accommodating changes in the subsurface environment and/or loss of a transceiver 70 within the borehole 22. For example, hydrocarbon producing wells frequently experience increased water production over the life of the well. Increased water production will in turn increase the attenuation factor for a given region. By designing wireless telemetry system 10 for an initial 60% or less attenuation of the transmitted signal, the current invention provides the means for maintaining downhole communication in the event of increased water production or other subsurface change. The details concerning the number and position of transceivers 70 within the subsurface lossy environment will be described below with regard to the method of determining the placement of transceivers 70 within borehole 22.

In general, wireless telemetry system 10 comprises at least one surface transceiver 70 located outside of the lossy environment and at least one target transceiver 70 within the lossy environment. Typically, one or more intermediate transceivers 70 are located within the lossy environment as well. Intermediate transceivers 70 may also be target transceivers 70 when associated with a sensor 60 or a remotely operated tool such as but not limited to packer 38.

Any transceiver 70 may initiate an EM signal and any transceiver 70, including the surface transceiver 70 may be the target transceiver 70 of the EM signal. Transceivers 70 may be used to control remotely operable tools such as packer 38 or tester valve 50 or for transmitting data and information gathered by sensors 60. Normally, wireless telemetry system 10 will include a computer (not shown) or other similar device for interpreting sensor data and direction operation of remotely operable tools. Transceivers 70 of wireless telemetry system 10 are typically positioned within the lossy environment at locations determined to ensure signal reception between transceivers.

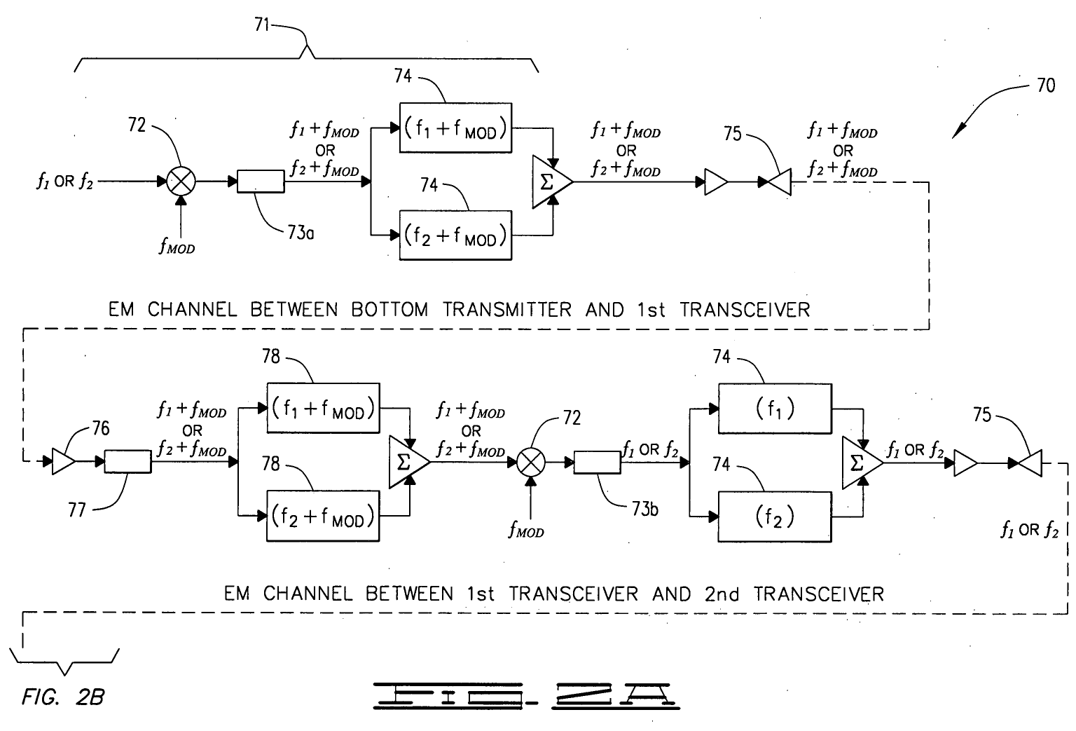

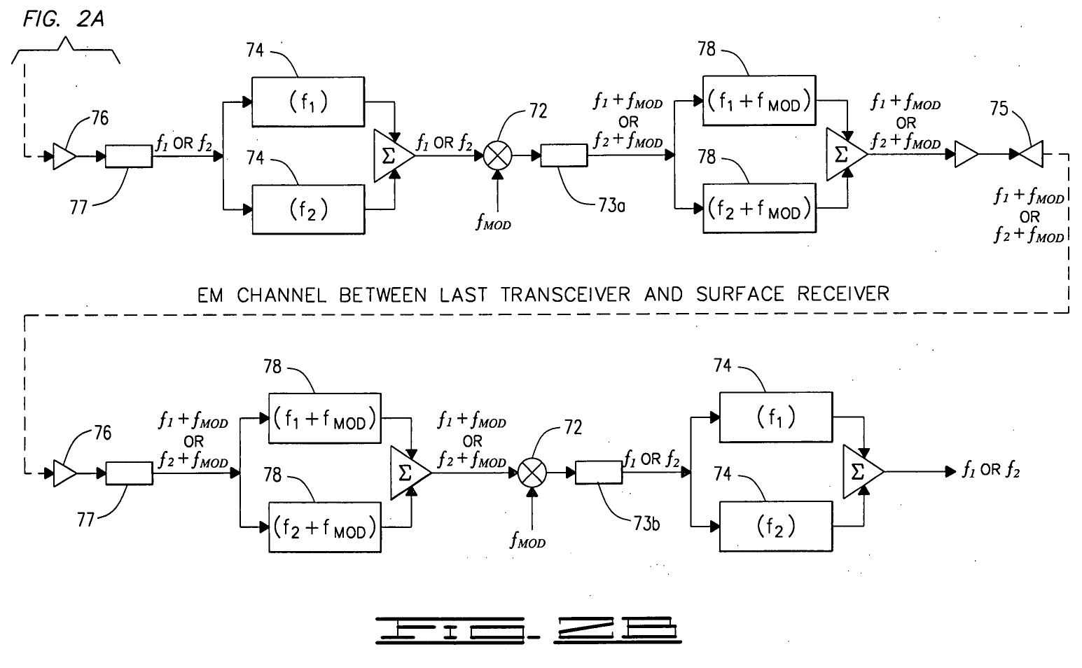

FIG. 2 provides a schematic representation of transceivers 70 utilized in wireless telemetry system 10 of the current invention. As shown in FIG. 2, the transmitting portion 71 of each transceiver 70 has a mixer 72 for combining a binary data signal with a modulation signal. The combined signal passes from the mixer to either a high pass filter 73a or low pass filter 73b. Thereafter the signal passes through one of two High-Q band pass filters 74. Thereafter, an antenna 75 transmits the signal.

As is known to those skilled in the art, high pass filter 73a removes unwanted frequency “noise” from the signal by attenuating those frequencies below a given frequency. Similarly, low pass filter 73b removes unwanted frequency “noise” from a signal by attenuating those frequencies above a given frequency. In this instance, High-Q band pass filter 74 selects a narrow range of frequencies compared with the absolute frequency at which it operates. Accordingly, the transceivers of the current invention provide a focused high frequency signal capable of carrying large quantities of data. Although functional from very low frequencies to very high frequencies, the transceivers preferably will operate at frequencies between about 15 Hz and about 5 kHz. Frequencies above 5 kHz are suitable for use in the current invention; however, higher frequencies will require closer spacing of transceivers 70 and greater number thereof within borehole 22. Further, as discussed above, lower EM frequencies will limit the data transmission rate. Therefore, practical limitations on the number of transceivers positioned in the borehole 22 and data rate desired will dictate the lower and upper frequency limits.

With continued reference to FIG. 2, the receiving portion 80 of transceiver 70 has a receiving antenna 82 linked with a band pass filter 84 set to a predetermined frequency. Preferably, band pass filter 84 can be tuned to different frequencies. Band pass filter 84 responds to signals on the pre-determined frequency and passes the signals at this frequency to High-Q band pass filter 86. As in transmitting portion 71, High-Q band pass filter 86 selects a narrow frequency and passes the frequency to transmitting portion 71. As is known to those skilled in the art, the final transceiver 70 communicates with a computer or other device (not shown) suitable for interpreting the signal.

Further, transceivers 70 of the current invention are preferably controllable from the surface in response to a transmitted signal. Thus, if the EM signal is not received at the surface, transceivers 70 will be directed to operate at lower frequency. Although the lower frequency will reduce the data transmission rate, the lower frequency will also improve EM signal strength throughout borehole 22. In one embodiment, the transceivers 70 will be set to default to a lower frequency when data is not received within a given period of time. In this manner, transceivers 70 will continually adjust the receiving and transmitting frequencies until a frequency capable of transmitting a signal of sufficient strength is determined. Thus, wireless telemetry system 10 automatically adjusts to changes in the lossy environment which alter the attenuation factor along the path of the EM signal through borehole 22.

II. Methods for Positioning Transceivers in a Lossy Environment

In another embodiment, the current invention provides a method for positioning transceivers 70 in a lossy environment. This method provides the ability to continuously transmit at least one EM signal through the lossy environment from an initial transceiver 70 to a final transceiver 70. When necessary, the method of the current invention includes the step of creating a passageway through the lossy media. For the purposes of this disclosure, a passageway can be any opening penetrating the lossy environment. For example, the passageway may be a mineshaft (not shown) or a borehole 22. Thus, the ability of the current invention to provide real time communication between the surface 90 and downhole sensors 60 and/or downhole tools such as packer 38 and valve 50 is particularly useful in hydrocarbon producing boreholes 22.

Alternatively, monitoring sensors 60 and transceivers 70 may be placed within a lossy environment by devices such as a cone penetrometer (not shown). When using a cone penetrometer system to place sensors 60 and transceivers 70, the passageway may collapse following placement of sensor 60 and transceiver 70 in the lossy environment. However, wireless telemetry system 10 does not require an open passageway in order to successfully transmit EM signals in real time.

In yet another alternative embodiment, positioning of transceiver 70 within the lossy environment may be achieved by pumping a self-contained transceiver through borehole 22 into formation 24. The ability to position sensors containing transceivers within a formation is taught by U.S. Pat. No. 6,538,576 assigned to Halliburton Energy Services, Inc., the assignee of the currently disclosed invention. The disclosure of U.S. Pat. No. 6,538,576 is incorporated herein by reference.

As noted above, a lossy environment attenuates electromagnetic (EM) signals reducing signal amplitude over distance. In general, higher frequencies experience greater degrees of attenuation. Therefore, in order to provide real time, high-bandwidth, EM signal transmission, the current invention must position the transceivers close enough to ensure a signal amplitude sufficient for reception.

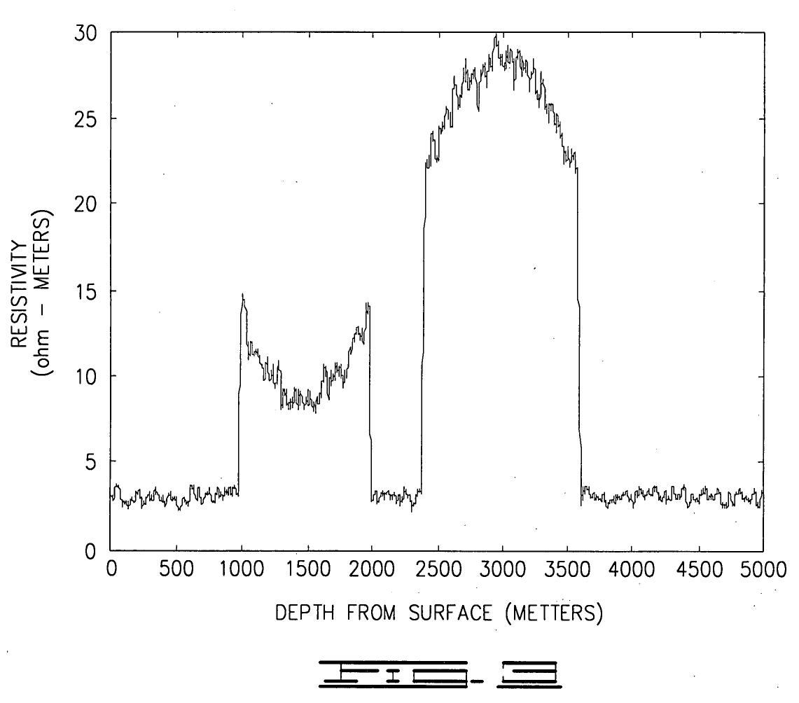

In order to provide a signal having sufficient amplitude for reception, the method of the current invention first determines the nature of the lossy environment along the intended path of the EM signal. For the purposes of this discussion, the lossy environment is subterranean formation 24 depicted in FIG. 1 and the intended path of the EM signal is borehole 22. Subterranean formation 24 may consist of several differing layers 24a through 24e. With regard to the attenuation of EM signals, the primary formation characteristics of interest are permeability (μ), conductivity (σ) and resistivity (ρ). These formation characteristics are normally obtained from well logs prepared during or after drilling or from other formation tests conducted subsequent to drilling. FIG. 3 represents a theoretical well log for a well drilled to a depth of 5000 meters. In FIG. 3, resistivity (ohm-meters) is plotted versus depth.

Preferably, the signal strength or attenuation for an EM signal passing through borehole 22 will be the same at each receiving transceiver. However, those skilled in the art will recognize that resistivity is not constant throughout subterreanean formation. For example, the theoretical resistivity log of FIG. 3, demonstrates how resistivity can change through a subterreanan formation. As resistivity changes the attenuation factor (AF) also changes. Therefore, the method of the current invention uses the AF for each portion of subterreanan formation 24 to determine the preferred location of each transceiver 70. According to the methods of the current invention, the preferred method for determining the AF of formation 24 and subsequently determining the positions of transceivers 70 throughout borehole 22 is to treat formation 24 as infinite layers of varying resistivity. The attenuation equation for a short interval is then used to approximate the attenuation across a subterranean zone of varying resistance using resistivity log information in the following manner.

If the attenuation over an interval is assumed to be constant from one reading to the next, the equation for attenuation may be applied to each interval of the well to compute the local attenuation for all intervals within formation 24. The attenuation for each of these small intervals can be added together to compute the overall attenuation for a specific zone of a well. If the contributions of all the small intervals are multiplied together, the attenuation from the top to the bottom of the borehole may be computed for a specific frequency.

For the entire depth of borehole 22, the exact expression of the attenuation factor is:

$$AF ( depth ) = {ⅇ}^{- {\int }_{0}^{depth} \frac{1}{skindepth ( z )} ⅆ z} = {ⅇ}^{- {\int }_{0}^{depth} \frac{1}{500 \sqrt{\frac{ρ ( z )}{f}}} ⅆ z} = {ⅇ}^{- 0.002 \sqrt{f} {\int }_{0}^{depth} \frac{1}{\sqrt{ρ ( z )}} ⅆ z}$$

which can be approximated by:

$$AF ( depth ) \approx {ⅇ}^{- {\sum }_{n = 1}^{N} \frac{Δ {z}_{n}}{{skindepth}_{n}} } = {ⅇ}^{- {\sum }_{n = 1}^{N} \frac{Δ {z}_{n}}{500 \sqrt{\frac{{ρ}_{n}}{f}}} } = {ⅇ}^{- 0.002 \sqrt{f} {\sum }_{n = 1}^{N} \frac{Δ {z}_{n}}{\sqrt{{ρ}_{n}}} }$$

where the entire length from the surface (z=0) to the bottom (z=depth) is broken up into N sections of length Dzₙ with skin depth skindepthₙ or resistivity ρₙ. The preceding equation can also be expressed in the following manner:

$$AF ( depth ) \approx {ⅇ}^{- 0.002 \sqrt{f} {\sum }_{n = 1}^{N} \frac{Δ {z}_{n}}{\sqrt{{ρ}_{n}}} } = ( {ⅇ}^{- 0.002 \sqrt{f} \frac{Δ {z}_{1}}{\sqrt{{ρ}_{1}}} } ) ( {ⅇ}^{- 0.002 \sqrt{f} \frac{Δ {z}_{2}}{\sqrt{{ρ}_{2}}} } ) ⋯ ( {ⅇ}^{- 0.002 \sqrt{f} \frac{Δ {z}_{N}}{\sqrt{{ρ}_{N}}} } ) .$$

The method described above can be used to determine where to place EM transceivers such that EM signal strength at each receiving transceiver 70 is approximately the same over the entire length of borehole 22 for a given transmission power and frequency. After computing the attenuation profile for the length of the well, transceivers 70 are preferably positioned within borehole 22 in a manner capable of permitting real time transmission of EM signals throughout the length of borehole 22. Those skilled in the art will recognize the multitude of methods for positioning transceiver 70 in borehole 22 and other passageways. For example, in the case of borehole 22, transceiver 70 can be attached to string 34 in a manner similar to any other tool.

In general, wireless telemetry system 10 will perform satisfactorily at very high levels of signal attenuation. The only requirement for operation of wireless telemetry system 10 is an electromagnetic signal with sufficient amplitude to permit reception by transceiver 70. Preferably, signal attenuation between transceivers 70 of wireless telemetry system 10 will not exceed about 98%; however, the distance between transceivers 70 will more preferably ensure greater signal transmission strength. As discussed above, the preferred distance between each transceiver 70 is a distance resulting in an AF of about 0.4 or less. Stated in other terms, the signal attenuation between transceivers 70 is most preferably about 60% or less.

However, in an alternative embodiment, the method of the current invention positions transceivers 70 of wireless telemetry system an equal distance apart throughout the lossy environment. In this embodiment, no effort is made to place transceivers 70 in a manner designed to provide approximately the same signal attenuation from one transceiver 70 to the next. Rather, in this embodiment, the maximum AF over the length of the EM transmission path is determined and the maximum distance between transceivers 70 calculated for the preferred range of frequencies to be used. Subsequently, all transceivers within the lossy environment are placed at a distance apart designed to ensure signal reception at the maximum AF. While this method simplifies construction of wireless telemetry system 10, it will likely increase the number of transceivers 70 used in any given application.

In most instances, the preferred arrangement for wireless telemetry system 10 will comprise at least one transceiver 70 located within the lossy environment and at least one transceiver 70 outside of the lossy environment. In the case of a well, mine, cave or other subsurface lossy environment, the system will preferably comprise two or more transceivers 70 within the subsurface lossy environment and one or more transceivers on the surface.

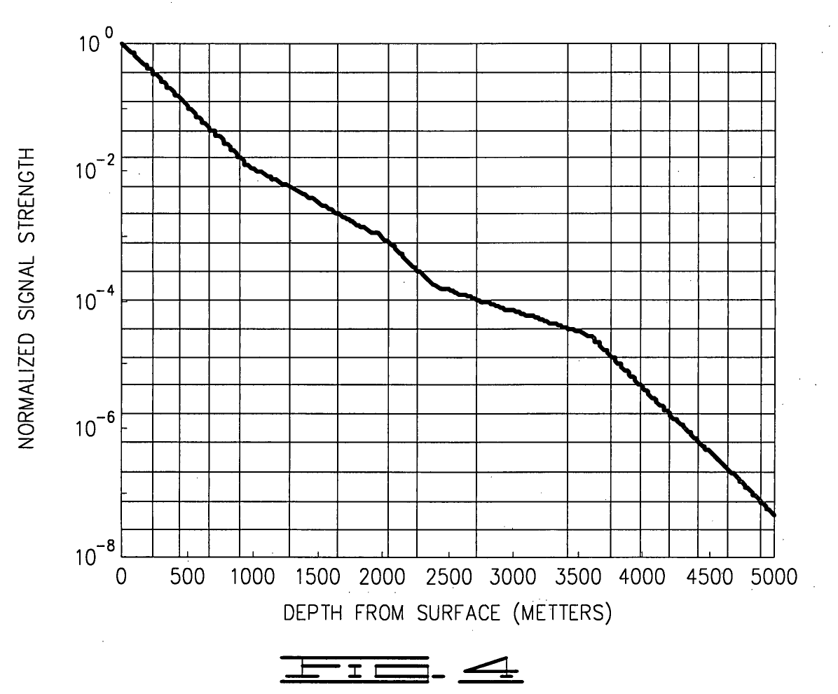

The following discussion relating to FIGS. 3 and 4 will aid in the understanding of the current invention. In this theoretical example the transceiver locations will be selected such that the AF between locations will be about 0.36. As known to those skilled in the art, an AF of 0.36 equates to a reduction in signal amplitude of 64% from one location to the next. This example uses the sample resistivity plot of FIG. 3 and a frequency of 15 Hz.

The theoretical data from FIG. 3 is used in the above AF equation to generate a signal attenuation plot as depicted in FIG. 4. FIG. 4 graphically represents the normalized signal strength of a 15 Hz EM signal versus depth from the surface. FIG. 4 reflects signal attenuation as a decrease in normalized signal strength. Reading FIG. 4 in view of FIG. 3 one recognizes that EM signal attenuation is greatest in areas of low resistivity. As a result, installation of wireless telemetry system 10 in theoretical borehole 22 would require closer placement of transceivers 70 in the first 1000 meters and last 1000 meters of borehole 22. In contrast, areas of high resistivity do not have significant attenuation factors. Accordingly, transceivers may be placed at greater distances while maintaining the desired EM signal strength at transceiver 70. Thus, the area of high resistivity between 2500 and 3500 meters attenuates the EM signal to the same degree as the low resistivity area between 4000 and 4500 meters.

The vertical lines on FIG. 4 represent the distance between transceivers 70 necessary to achieve the desired minimum attenuation in this example. According to FIG. 4, a wireless telemetry system 10 in this lossy environment would require seventeen subsurface transceivers 70 and one transceiver 70 at the surface in order to transmit an EM signal through hypothetical borehole 22 at approximately 64% signal attenuation. Depending on the location of sensors 60 any one of subsurface transceivers 70 may initiate an EM signal for interpretation at the surface following reception by surface transceiver 70. For example, if the transceiver 70 located at approximately 3400 meters were associated with a sensor 60 designed to detect the presence of water, transceiver 70 would initiate an EM signal at the preselected frequency. This signal will travel to the adjacent intermediate transceiver 70 which immediately will convey the signal to the next intermediate transceiver 70 and so on through borehole 22 until the EM signal is received at the surface by surface transceiver 70, i.e. the target transceiver 70, and interpreted by a computer or other similar device. Since the signal is received in real time at the surface, the operator or preferably the computer can react to the data received and immediately transmit a signal to the appropriate downhole device. When transmitting a signal downhole, the targeted transceiver 70 is the one associated with the downhole device.

III. Methods for Transmitting Data Through a Lossy Environment

Additionally, the above described wireless telemetry system 10 provides for real time transmission of an EM signal through the lossy environment or the simultaneous transmission of two EM signals in the same or opposing directions along the network of transceivers 70. The methods for transmitting EM signals through a lossy environment include the steps described above for positioning wireless transceivers within the lossy environment. Specifically, the current invention initially determines the AF for the selected path of the EM signal through the lossy environment. Following determination of the AF, the operator determines either the preferred range of transmission frequencies or the preferred spacing of transceivers 70 necessary to achieve the desired signal attenuation.

For example, if greater data transmission ability is desired, a higher range of frequencies will be necessary for transmitting the EM signal. As discussed above, higher frequencies experience a greater degree of signal attenuation over distance when passing through lossy media. Therefore, the use of higher frequencies will require closer spacing of transceivers 70 to provide the desired signal attenuation. In contrast, lower frequencies will travel greater distances prior to experiencing the same degree of signal attenuation. Thus, the operator may choose to operate at a lower data transmission rate thereby permitting use of lower frequencies and reducing the number of transceivers 70 in wireless telemetry system 10. As noted above, wireless telemetry system 10 is capable of operating over frequencies ranging from about 15 Hz to about 5 kHz. Therefore, the operator of wireless telemetry system 10 has a wide range of frequencies available.

Following determination of the desired operating frequencies and positioning of transceivers 70, the current invention transmits EM signals over wireless telemetry system 10. When transmitting data through wireless telemetry system 10, at least two frequencies will be used. For example, data obtained from sensor 60 will be transmitted on a first frequency by the transceiver 70. An intermediate transceiver 70 receives the signal and immediately rebroadcasts it on a different frequency. Preferably, the same two frequencies will be alternated from transceiver 70 to transceiver 70 until the data is received by the target transceiver 70. As noted above, target transceiver 70 may be surface transceiver 70 associated with a computer for interpreting the received data or another transceiver 70 located within borehole 22 and controllably linked with a downhole tool.

When simultaneously transmitting two EM signals in either two directions or a single direction through wireless telemetry system 10, two transceivers 70 will be positioned at each selected point within borehole 22. Preferably, each pair of transceivers 70 is located within a single housing (not shown). In operations at least four frequencies will be used to simultaneously transmit two EM signals through borehole 22. As previously discussed the use of two discrete frequencies enables transmission of data in one direction without interference between transmitted signals. Accordingly, simultaneously transmission of two EM signals requires at least four distinct frequencies to preclude interference between the transmitted signals. Except for the use of additional frequencies to preclude interference, the method of transmitting two signals simultaneously along the network of transceivers 70 remains the same as described above. Thus, the current invention provides a method of simultaneously transmitting two EM signals either in a single direction or in a bi-directional manner through a lossy environment.

The method for transmitting data through a lossy environment using wireless telemetry system 10 also provides for continuous transmission of data in the event of the loss of a transceiver 70 or a change in the subsurface environment. For example, an increase in water production may alter the AF of a section of wellbore 22 sufficiently to preclude transmission of a data signal at the preferred transmission frequency. Transceivers 70 can be preprogrammed to default to a lower frequency if transceivers 70 have not received a transmission within a predetermined period of time. In addition, only those transceivers in the region of the subsurface change in environment or faulty transceiver 70 can default to a lower frequency.

While the current invention has been described primarily in the environment of a borehole 22, other applications of the current invention will be apparent to those skilled in the art. For example, without limiting the scope of the current invention, the methods and systems of the current invention will also be useful for providing communications through mines and caves. Other embodiments of the current invention will be apparent to those skilled in the art. Thus, the foregoing specification is considered exemplary with the true scope and spirit of the invention being indicated by the following claims.

1. A method for positioning wireless transceivers in a lossy environment, comprising the steps of:
determining the attenuation factor throughout the lossy environment;
selecting at least one transmission frequency; and
positioning the transceivers a distance apart, the distance selected to ensure reception of an electromagnetic signal transmitted at the selected frequency.

2. The method of claim 1, further comprising the step of determining the distance between transceivers which will permit transmission of an electromagnetic signal with equal to or less than 98% signal attenuation.

3. The method of claim 1, further comprising the step of determining the distance between transceivers which will permit transmission of an electromagnetic signal with equal to or less than 90% signal attenuation.

4. The method of claim 1, further comprising the step of determining the distance between transceivers which will permit transmission of an electromagnetic signal with equal to or less than 80% signal attenuation.

5. The method of claim 1, further comprising the step of determining the distance between transceivers which will permit transmission of an electromagnetic signal with equal to or less than 70% signal attenuation.

6. The method of claim 1, further comprising the step of determining the distance between transceivers which will permit transmission of an electromagnetic signal with equal to or less than 60% signal attenuation.

7. The method of claim 1, wherein the lossy environment is penetrated by at least one borehole.

8. The method of claim 1, wherein the lossy environment is penetrated by at least one mineshaft.

9. The method of claim 1, wherein the lossy environment surrounds a cave.

10. The method of claim 1, wherein the transmission frequency is between about 15 Hz and 5 kHz.

11. The method of claim 1, wherein the step of determining the attenuation factor throughout the lossy environment comprises the step of determining the resistivity throughout the lossy environment.

12. The method of claim 1, wherein at least one transceiver is located within the lossy environment and at least one transceiver is outside the lossy environment.

13. The method of claim 1, wherein at least two transceivers are located within the lossy environment.

14. The method of claim 1, wherein the transceivers are positioned in a manner to produce substantially the same signal attenuation from one transceiver to another transceiver.

15. A method for positioning electromagnetic transceivers within a borehole comprising the steps of:
determining the resistivity of a given length of borehole;
determining the attenuation profile at a selected frequency for the given length of borehole;
selecting at least one transmission frequency; and,
positioning the transceivers in the given length of borehole, the distance from one receiver to the next receiver being selected to ensure signal reception between transceivers.

16. The method of claim 15, wherein the electromagnetic transceivers operate at frequencies ranging from about 15 Hz to about 5 kHz.

17. The method of claim 15, further comprising the step of determining the distance between transceivers which will permit transmission of an electromagnetic signal with equal to or less than 98% signal attenuation.

18. The method of claim 15, further comprising the step of determining the distance between transceivers which will permit transmission of an electromagnetic signal with equal to or less than 90% signal attenuation.

19. The method of claim 15, further comprising the step of determining the distance between transceivers which will permit transmission of an electromagnetic signal with equal to or less than 80% signal attenuation.

20. The method of claim 15, further comprising the step of determining the distance between transceivers which will permit transmission of an electromagnetic signal with equal to or less than 70% signal attenuation.

21. The method of claim 15, further comprising the step of determining the distance between transceivers which will permit transmission of an electromagnetic signal with equal to or less than 60% signal attenuation.

22. The method of claim 15, wherein the transceivers are positioned in a manner to produce substantially the same signal attenuation from one transceiver to another transceiver.

23. A method for transmitting an electromagnetic signal through a subsurface lossy environment comprising the steps of:
determining the attenuation factor for the path of the electromagnetic signal through the lossy environment;
selecting at least one transmission frequency;
positioning at least one transceiver within the lossy environment and at least one transceiver outside the lossy environment, the distance between the transceivers being selected to ensure reception of an electromagnetic signal; and,
transmitting an electromagnetic signal from one transceiver to the other transceiver through the lossy environment at the selected transmission frequency.

24. The method of claim 23, comprising positioning at least two transceivers within the lossy environment and at least one transceiver outside the lossy environment and wherein the transceiver outside the lossy environment transmits an electromagnetic signal through the lossy environment to an intermediate transceiver and the intermediate transceiver immediately conveys the electromagnetic signal through the lossy environment to another transceiver.

25. The method of claim 23, comprising positioning at least two transceivers within the lossy environment and at least one transceiver outside the lossy environment and wherein one transceiver within the lossy environment transmits an electromagnetic signal through the lossy environment to at least one intermediate transceiver within the lossy environment and the intermediate transceiver immediately conveys the electromagnetic signal through the lossy environment to another transceiver within the lossy environment or to the transceiver outside the lossy environment.

26. The method of claim 23, wherein the distance produces equal to or less than about 98% signal attenuation.

27. The method of claim 23, wherein the distance produces equal to or less than about 90% signal attenuation.

28. The method of claim 23, wherein the distance produces equal to or less than about 80% signal attenuation.

29. The method of claim 23, wherein the distance produces equal to or less than about 70% signal attenuation.

30. The method of claim 23, wherein the distance produces equal to or less than about 60% signal attenuation.

31. The method of claim 23, wherein the lossy environment is penetrated by at least one borehole.

32. The method of claim 23, wherein the lossy environment is penetrated by at least one mineshaft.

33. The method of claim 23, wherein the lossy environment surrounds a natural opening.

34. The method of claim 23, wherein the transmission frequency is between about 15 Hz and 5 kHz.

35. The method of claim 23, wherein the step of determining the attenuation factor comprises the step of determining the resistivity for the path of the electromagnetic signal through the lossy environment.

36. The method of claim 23, wherein the transmission frequency automatically changes in response to a change in the attenuation factor.

37. The method of claim 23, wherein the transmission frequency automatically changes to a lower frequency in response to a change in the attenuation factor.

38. The method of claim 23, wherein the transmission frequency automatically changes when a transceiver does not receive a transmission within a predetermined period of time.

39. The method of claim 23, wherein the transmission frequency automatically changes to a lower frequency when a transceiver does not receive a transmission within a predetermined period of time.

40. The method of claim 24, wherein the transceivers are positioned in a manner to produce substantially the same signal attenuation from one transceiver to another transceiver.

41. The method of claim 23, wherein a transceiver receiving a signal retransmits the signal on a different frequency from the received signal.

42. A method for transmitting an electromagnetic signal through a lossy environment comprising the steps of:
determining the attenuation factor throughout the lossy environment;
selecting at least one transmission frequency;
positioning at least two transceivers a distance apart within the lossy environment, the distance between the transceivers being selected to ensure reception of an electromagnetic signal; and,
transmitting an electromagnetic signal from one transceiver to another transceiver through the lossy environment.

43. The method of claim 42, comprising positioning at least three transceivers within the lossy environment, wherein a first transceiver transmits an electromagnetic signal to a second transceiver and the second transceiver immediately conveys the electromagnetic signal to the third transceiver.

44. The method of claim 42, wherein the distance produces equal to or less than about 98% signal attenuation.

45. The method of claim 42, wherein the distance produces equal to or less than about 90% signal attenuation.

46. The method of claim 42, wherein the distance produces equal to or less than about 80% signal attenuation.

47. The method of claim 42, wherein the distance produces equal to or less than about 70% signal attenuation.

48. The method of claim 42, wherein the distance produces equal to or less than about 60% signal attenuation.

49. The method of claim 42, wherein the lossy environment is penetrated by at least one borehole.

50. The method of claim 42, wherein the lossy environment is penetrated by at least one mineshaft.

51. The method of claim 42, wherein the lossy environment surrounds a natural opening.

52. The method of claim 42, wherein the transmission frequency is between about 15 Hz and 5 kHz.

53. The method of claim 42, wherein the step of determining the attenuation factor comprises the step of determining the resistivity for the path of the electromagnetic signal through the lossy environment.

54. The method of claim 43, wherein a transceiver receiving a signal retransmits the signal on a different frequency from the received signal.

55. The method of claim 42, wherein the transmission frequency automatically changes in response to a change in the attenuation factor.

56. The method of claim 42, wherein the transmission frequency automatically changes to a lower frequency in response to a change in the attenuation factor.

57. The method of claim 42, wherein the transmission frequency automatically changes when a transceiver does not receive a transmission within a predetermined period of time.

58. The method of claim 42, wherein the transmission frequency automatically changes to a lower frequency when a transceiver does not receive a transmission within a predetermined period of time.

59. The method of claim 42, wherein the transceivers are positioned in a manner to produce substantially the same signal attenuation from one transceiver to another transceiver.

60. A method for the real time transmission of an electromagnetic signal from the surface through a lossy environment comprising the steps of:
determining the resistivity along the path of the electromagnetic signal through the lossy environment;
selecting at least one transmission frequency;
positioning a transceiver at the surface;
positioning at least one intermediate transceiver in the lossy environment;
positioning at least one target transceiver within the lossy environment, wherein the distance between each transceiver is that distance which will provide an attenuation factor low enough to permit reception of an electromagnetic signal transmitted at the selected frequency from one transceiver to another transceiver; and,
transmitting an electromagnetic signal in real time from the surface transceiver to at least one target transceiver, the electromagnetic signal passing through at least one intermediate transceiver prior to reception at a target transceiver.

61. The method of claim 60, wherein the distance between each transceiver is that distance which will produce equal to or less than about 98% signal attenuation.

62. The method of claim 60, wherein the distance between each transceiver is that distance which will produce equal to or less than about 90% signal attenuation.

63. The method of claim 60, wherein the distance between each transceiver is that distance which will produce equal to or less than about 80% signal attenuation.

64. The method of claim 60, wherein the distance between each transceiver is that distance which will produce equal to or less than about 70% signal attenuation.

65. The method of claim 60, wherein the distance between each transceiver is that distance which will produce equal to or less than about 60% signal attenuation.

66. The method of claim 60, wherein the lossy environment is penetrated by at least one borehole.

67. The method of claim 60, wherein the lossy environment is penetrated by at least one mineshaft.

68. The method of claim 60, wherein the lossy environment surrounds a cave.

69. The method of claim 60, wherein the transmission frequency is between about 15 Hz and 5 kHz.

70. The method of claim 60, wherein the transmission frequency automatically changes in response to a change in the attenuation factor.

71. The method of claim 60, wherein the transmission frequency automatically changes to a lower frequency in response to a change in the attenuation factor.

72. The method of claim 60, wherein the transmission frequency automatically changes when a transceiver does not receive a transmission within a predetermined period of time.

73. The method of claim 60, wherein the transmission frequency automatically changes to a lower frequency when a transceiver does not receive a transmission within a predetermined period of time.

74. The method of claim 60, wherein the transceivers are positioned in a manner to produce substantially the same signal attenuation from one transceiver to another transceiver.

75. The method of claim 60, wherein a transceiver receiving a signal retransmits the signal on a different frequency from the received signal.

76. A method for the real time transmission of an electromagnetic signal through a lossy environment comprising the steps of:
determining the resistivity along the path of the electromagnetic signal through the lossy environment;
selecting at least one transmission frequency;
positioning at least one transceiver at the surface;
positioning at least one intermediate transceiver in the lossy environment;
positioning at least one target transceiver within the lossy environment, wherein the distance between each transceiver is that distance which will provide an attenuation factor low enough to permit reception of an electromagnetic signal transmitted at the selected frequency from one transceiver to another transceiver; and,
transmitting an electromagnetic signal in real time from at least one target transceiver or surface transceiver through at least one intermediate transceiver prior to reception by at least one target transceiver or surface transceiver.

77. The method of claim 76, wherein the distance between each transceiver is that distance which will produce equal to or less than about 98% signal attenuation.

78. The method of claim 76, wherein the distance between each transceiver is that distance which will produce equal to or less than about 90% signal attenuation.

79. The method of claim 76, wherein the distance between each transceiver is that distance which will produce equal to or less than about 80% signal attenuation.

80. The method of claim 76, wherein the distance between each transceiver is that distance which will produce equal to or less than about 70% signal attenuation.

81. The method of claim 76, wherein the distance between each transceiver is that distance which will produce equal to or less than about 60% signal attenuation.

82. The method of claim 76, wherein the lossy environment is penetrated by at least one borehole.

83. The method of claim 76, wherein the lossy environment is penetrated by at least one mineshaft.

84. The method of claim 76, wherein the lossy environment surrounds a cave.

85. The method of claim 76, wherein the transmission frequency is between about 15 Hz and 5 kHz.

86. The method of claim 76, wherein the transmission frequency automatically changes in response to a change in the attenuation factor.

87. The method of claim 76, wherein the transmission frequency automatically changes to a lower frequency in response to a change in the attenuation factor.

88. The method of claim 76, wherein the transmission frequency automatically changes when a transceiver does not receive a transmission within a predetermined period of time.

89. The method of claim 76, wherein the transmission frequency automatically changes to a lower frequency when a transceiver does not receive a transmission within a predetermined period of time.

90. The method of claim 76, wherein the transceivers are positioned in a manner to produce substantially the same signal attenuation from one transceiver to another transceiver.

91. The method of claim 76, wherein a transceiver receiving a signal retransmits the signal on a different frequency from the received signal.

92. A method for transmitting data through a subterranean formation using electromagnetic signals comprising the steps of:
forming at least one passageway through at least part of a subterranean formation;
determining the resistivity of the subterranean formation along the passageway;
selecting at least one frequency for transmitting data;
determining the attenuation profile of the subterranean formation for the frequencies to be used in the subterranean formation;
positioning transceivers in the passageway such that the amplitude of an electromagnetic signal transmitted between any two transceivers is sufficient to ensure signal reception; and,
transmitting data through the borehole using electromagnetic signals.

93. The method of claim 92, wherein the electromagnetic signals are transmitted at frequencies ranging from about 15 Hz to about 5 kHz.

94. The method of claim 92, wherein the passageway is a borehole penetrating the subterranean formation.

95. The method of claim 92, wherein the passageway is a mineshaft penetrating the subterranean formation.

96. The method of claim 92, the transceivers are positioned in the passageway at locations selected to produce equal to or less than about 98% signal attenuation from one transceiver to the next transceiver.

97. The method of claim 92, the transceivers are positioned in the passageway at locations selected to produce equal to or less than about 90% signal attenuation from one transceiver to the next transceiver.

98. The method of claim 92, the transceivers are positioned in the passageway at locations selected to produce equal to or less than about 80% signal attenuation from one transceiver to the next transceiver.

99. The method of claim 92, the transceivers are positioned in the passageway at locations selected to produce equal to or less than about 70% signal attenuation from one transceiver to the next transceiver.

100. The method of claim 92, the transceivers are positioned in the passageway at locations selected to produce equal to or less than about 60% signal attenuation from one transceiver to the next transceiver.

101. The method of claim 92, wherein the step of transmitting data utilizes an electromagnetic frequency between about 15 Hz and 5 kHz.

102. The method of claim 92, wherein the transmission frequency automatically changes in response to a change in the attenuation factor.

103. The method of claim 92, wherein the transmission frequency automatically changes to a lower frequency in response to a change in the attenuation factor.

104. The method of claim 92, wherein the transmission frequency automatically changes when a transceiver does not receive a transmission within a predetermined period of time.

105. The method of claim 92, wherein the transmission frequency automatically changes to a lower frequency when a transceiver does not receive a transmission within a predetermined period of time.

106. The method of claim 92, wherein the transceivers are positioned in a manner to produce substantially the same signal attenuation from one transceiver to another transceiver.

107. The method of claim 92, wherein a transceiver receiving a signal retransmits the signal on a different frequency from the received signal.

108. A method for simultaneously transmitting data upwards and downwards through a borehole using electromagnetic signals comprising the steps of:
drilling a borehole through at least part of a subterranean formation;
determining the resistivity of the subterranean formation along the path of the borehole;
selecting at least one frequency for transmitting data;
determining the attenuation profile of the subterranean formation along the path of the borehole for the frequencies to be used in the downhole environment;
positioning at least two pairs of transceivers in the borehole such that signal attenuation between transceivers is substantially identical throughout the borehole; and,
transmitting data upwards and downwards through the borehole using electromagnetic signals.

109. The method of claim 108, wherein the electromagnetic frequencies range from about 15 Hz to about 5 kHz.

110. The method of claim 108, the transceivers are positioned in the borehole at locations selected to produce equal to or less than about 98% signal attenuation from one transceiver to the next transceiver.

111. The method of claim 108, the transceivers are positioned in the borehole at locations selected to equal to or produce less than about 90% signal attenuation from one transceiver to the next transceiver.

112. The method of claim 108, the transceivers are positioned in the borehole at locations selected to produce equal to or less than about 80% signal attenuation from one transceiver to the next transceiver.

113. The method of claim 108, the transceivers are positioned in the borehole at locations selected to produce equal to or less than about 70% signal attenuation from one transceiver to the next transceiver.

114. The method of claim 108, the transceivers are positioned in the borehole at locations selected to produce equal to or less than about 60% signal attenuation from one transceiver to the next transceiver.

115. The method of claim 108, wherein the step of transmitting data utilizes an electromagnetic frequency between about 15 Hz and 5 kHz.

116. The method of claim 108, wherein the transmission frequency automatically changes in response to a change in the attenuation factor.

117. The method of claim 108, wherein the transmission frequency automatically changes to a lower frequency in response to a change in the attenuation factor.

118. The method of claim 108, wherein the transmission frequency automatically changes when a transceiver does not receive a transmission within a predetermined period of time.

119. The method of claim 108, wherein the transmission frequency automatically changes to a lower frequency when a transceiver does not receive a transmission within a predetermined period of time.

120. The method of claim 108, wherein the transceivers are positioned in a manner to produce substantially the same signal attenuation from one transceiver to another transceiver.

121. The method of claim 108, wherein a transceiver receiving a signal retransmits the signal on a different frequency from the received signal.

122. A wireless telemetry system comprising:
at least two transceivers capable of sending and receiving electromagnetic signals positioned within a lossy environment;
a distance between the transceivers such that the amplitude of an electromagnetic signal transmitted from one transceiver to another is sufficient to ensure reception.

123. The wireless telemetry system of claim 122, wherein the distance between transceivers produces equal to or less than 98% attenuation of the electromagnetic signal transmitted from one transceiver to another transceiver.

124. The wireless telemetry system of claim 122, wherein the lossy environment is a subterranean formation penetrated by a borehole and the transceivers are positioned within the borehole.

125. The wireless telemetry system of claim 122, wherein the lossy environment is a mineshaft and the transceivers are positioned within the mineshaft.

126. The wireless telemetry system of claim 122, wherein the lossy environment is a natural opening in the earth and the transceivers are positioned within the opening.

127. The wireless telemetry system of claim 122, wherein the transceivers are capable of sending and receiving electromagnetic signals at frequencies between about 15 Hz and about 5 kHz.

128. The wireless telemetry system of claim 122, wherein the distance between transceivers produces equal to or less than 90% attenuation of the electromagnetic signal transmitted from one transceiver to another transceiver.

129. The wireless telemetry system of claim 122, wherein the distance between transceivers produces equal to or less than 80% attenuation of the electromagnetic signal transmitted from one transceiver to another transceiver.

130. The wireless telemetry system of claim 122, wherein the distance between transceivers produces equal to or less than 70% attenuation of the electromagnetic signal transmitted from one transceiver to another transceiver.

131. The wireless telemetry system of claim 122, wherein the distance between transceivers produces equal to or less than 60% attenuation of the electromagnetic signal transmitted from one transceiver to another transceiver.

132. The wireless telemetry system of claim 122, wherein the distance between transceivers is identical.

133. The wireless telemetry system of claim 122, wherein the distance between transceivers is selected to provide substantially identical signal attenuation in an electromagnetic signal transmitted from one transceiver to another.

134. An transceiver system for transmitting electromagnetic signals through a lossy environment comprising:
at least two mixers for combining electromagnetic signals;
at least two high pass filters;
at least two band pass filters;
at least two high-Q band pass filters; and,
at least two transceivers.

135. The transceiver system of claim 134, wherein the system is an analog system.
